(19) United States
(12) Patent Application Publication
(10) Pub. No.: US 2016/0023806 A1
(43) Pub. Date: Jan. 28, 2016

(54) MANUAL VALVE, TANK WALL, AND DRAIN DEVICE HAVING THE SAME

(71) Applicant: DENSO International America, Inc., Southfield, MI (US)

(72) Inventor: Tara Thurston, FARMINGTON HILLS, MI (US)

(21) Appl. No.: 14/341,066

(22) Filed: Jul. 25, 2014

(51) Int. Cl. B65D 25/38; F16K 3/00

(52) U.S. Cl. CPC B65D 25/38; F16K 3/00

(57) ABSTRACT

A manual valve includes a knob and a stem projected from the knob. The stem has a pin and a recess. The pin is configured to be projected from the stem radially outward and to be retracted into the recess radially inward. The pin has a end surface configured to latch onto a pin seat when projected. The knob has a plug radially offset from a center axis of the stem.

### TECHNICAL FIELD

The present disclosure relates to a manual valve. The present disclosure relates to a tank wall. The present disclosure further relates to a drain device including the manual valve and the tank wall.

### BACKGROUND

Conventionally, a manual valve is equipped to a drain device for a tank of a fluidic device such as a radiator. A conventional manual valve may be, for example, screwed into a drain hole of a drain device. In such a configuration, the manual valve may be unscrewed to drain fluid accumulated in a tank. When the manual valve is unscrewed, the manual valve may be detached and lost.

### SUMMARY

The present disclosure addresses the above-described concerns.

According to an aspect of the present disclosure, a manual valve comprises a knob. The manual valve further comprises a stem projected from the knob. The stem has a first pin and a first recess. The first pin is configured to be projected from the stem radially outward and to be retracted into the first recess radially inward. The first pin has a first end surface configured to latch onto a first pin seat when projected. The knob has at least one plug radially offset from a center axis of the stem.

According to another aspect of the present disclosure, a tank wall of a tank is for receiving fluid. The tank wall comprises an insertion hole extending through the tank wall. The tank wall further comprises a drain passage extending through the tank wall to enable fluid to flow therethrough, the drain passage being offset radially from the insertion hole. The tank wall further comprises a first pin guide overlapped with the insertion hole in both an axial direction and a radial direction. The first pin guide has a length less than a length of the insertion hole in the axial direction. The first pin guide extends radially outward from the insertion hole and extends around a center axis of the insertion hole to form an arc hollow in the tank wall. The first pin guide has a first pin seat substantially at a right angle relative to the center axis of the insertion hole.

According to another aspect of the present disclosure, a drain device comprises a manual valve. The drain device further comprises a tank wall. The manual valve includes a knob and a stem, which is projected from the knob. The stem has a first pin and a first recess. The tank wall has an insertion hole, a first pin guide, and a drain passage. The first pin guide overlaps with the insertion hole in both an axial direction and a radial direction. The first pin guide extends radially outward from the insertion hole and extends around a center axis of the insertion hole to form an arc hollow to define a first pin seat in the tank wall. The first pin is projected from the stem radially outward to latch onto the first pin seat when the stem is inserted in the insertion hole. The knob is configured to rotate around the center axis of the stem, while the first end surface of the first pin is seated on the first pin seat.

### BRIEF DESCRIPTION OF THE DRAWINGS

The above and other objects, features and advantages of the present invention will become more apparent from the following detailed description made with reference to the accompanying drawings. In the drawings:

FIG. 1 is an exploded view showing a manual valve, a tank wall, and 0-rings of a drain device according to a first embodiment;

FIGS. 2A to 2D are sectional views showing a process to mount the manual valve onto the tank wall according to the first embodiment;

FIG. 3A is a front view showing the manual valve mounted to the tank wall and at a close position according to the first embodiment, and FIG. 3B is a front view showing the manual valve mounted to the tank wall and at a close position after rotation for about 90 degrees from a state of FIG. 3A;

FIGS. 4A is a sectional view showing a manual valve mounted to a tank wall according to a second embodiment, and FIG. 4B is a front view showing the manual valve mounted to the tank wall according to the second embodiment;

FIG. 5 is a view showing a manual valve according to a third embodiment; and

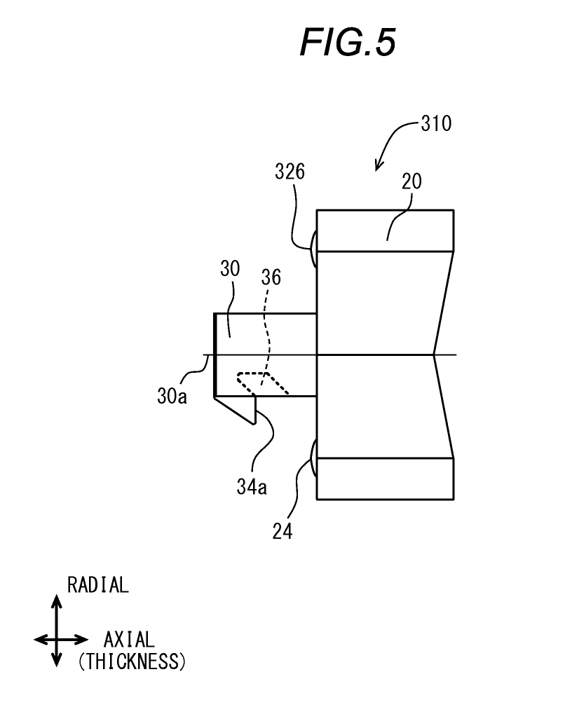

FIG. 6 is an exploded view showing a manual valve, a tank wall, and the O-ring of a drain device according to a fourth embodiment.

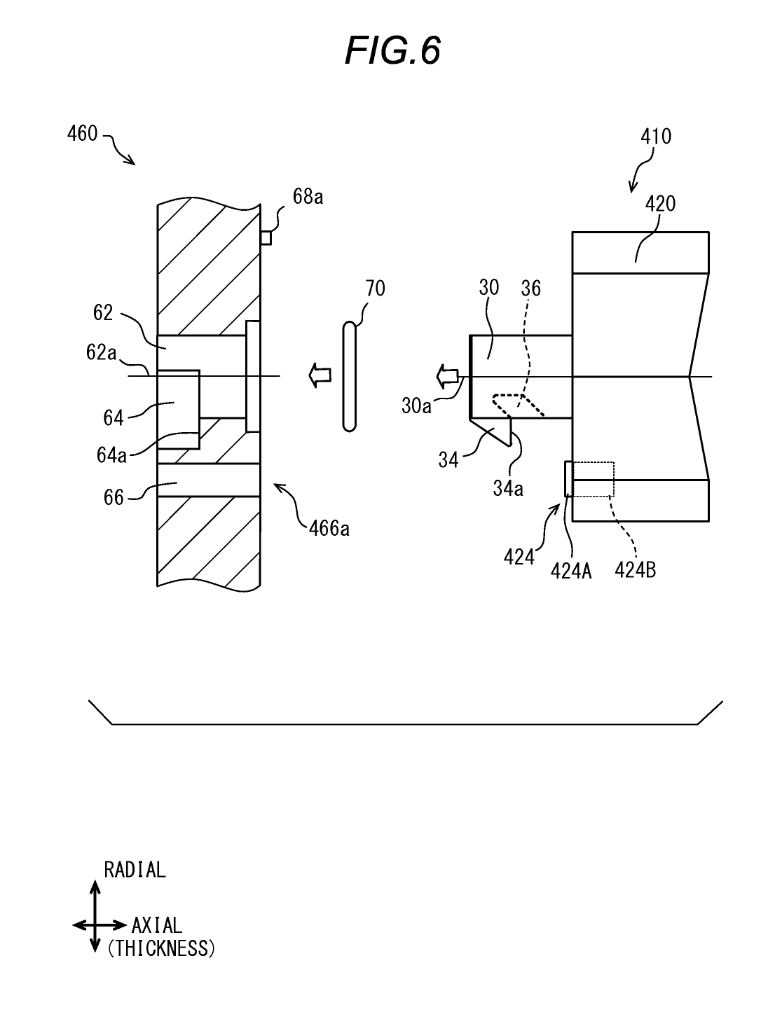

### DETAILED DESCRIPTION

In the following description, a radial direction is along an arrow represented by “RADIAL” in drawing(s). An axial direction is along an arrow represented by “AXIAL” in drawing(s). A thickness direction is along an arrow represented by “THICKNESS” in drawing(s). A circumferential direction is along an arrow represented by “CIRCUMFERENTIAL” in drawing(s).

### First Embodiment

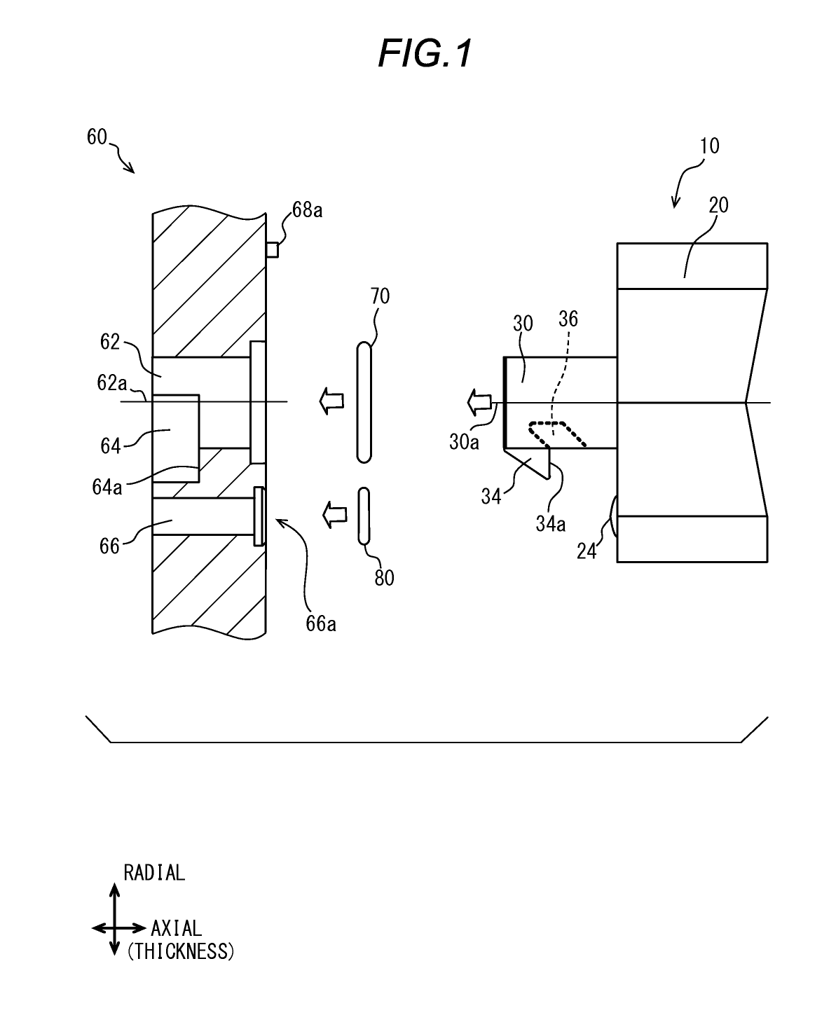

As follows, a first embodiment of the present disclosure will be described with reference to drawings. As shown in FIG. 1, a wall (tank wall) 60 is a part of a tank for receiving fluid. In the present example, the tank is a radiator tank for receiving cooling water. The tank is formed of, for example, a resin material.

The wall 60 has an insertion hole 62 and a drain passage 66. The insertion hole 62 is a through hole communicating with an interior of the tank. The insertion hole 62 has a dent to receive an O-ring 70.

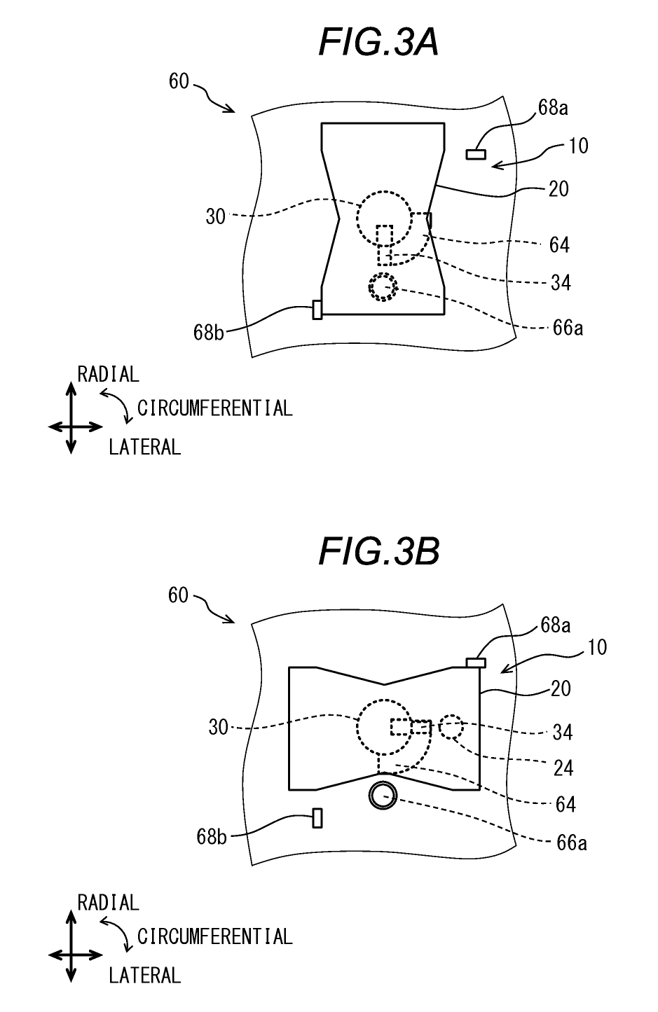

The drain passage 66 is located at a position offset from the insertion hole 62 in the radial direction. That is, the drain passage 66 does not overlap with the insertion hole 62. The drain passage 66 is a through hole communicating with an interior of the tank. The drain passage 66 has a dent to receive an O-ring 80. The drain passage 66 is configured to flow fluid, such as drain accumulated in the tank, through a drain port 66a. The wall 60 has a pin guide 64 formed to overlap with the insertion hole 62 in both the axial direction and the radial direction. The pin guide 64 has a length less than the insertion hole 62 in the axial direction. The pin guide 64 extends radially outward to form an arc hollow (FIG. 3A) in the wall 60. The pin guide 64 has a flat bottom surface defining a pin seat 64a. The pin seat 64a is at a right angle relative to a center axis 62a of the insertion hole 62 and/or a periphery of the insertion hole 62. The wall 60 has a flat seat surface on the right side in FIG. 1. The wall 60 is equipped with stoppers 68a, 68b, which are projected from the flat seat surface.

A valve (manual valve) 10 is formed of, for example, a resin material integrally in one piece. The valve 10 has a knob 20 and a stem 30. The knob 20 is in a shape easily pinched and twisted with fingers of a user. In the present example, the knob 20 is in a hand-drum-shape when viewed along the axial direction. The knob 20 has a flat seat surface on the left side in FIG. 1. The knob 20 has a plug 24, which is, for example, in a dome shape and is projected from the flat seat surface of the knob 20.

The stem 30 is a cylindrical member extended from the knob 20 in the axial direction. The stem 30 has a pin 34 and a recess 36. The pin 34 is projected in the radial direction outward from the circumferential periphery of the stem 30. The pin 34 has an end surface 34a at a right angle relative to a center axis 30a of the stem 30 and/or the circumferential periphery of the stem 30. The recess 36 is dented in the radial direction inward from the circumferential periphery of the stem 30. The pin 34 is cantilevered at one end. The pin 34 is resiliently pivoted at the one end and bendable relative to the recess 36. On receiving force inward in the radial direction, the pin 34 is resiliently bent in the radial direction inward and is retracted into the recess 36. On releasing the force, the pin 34 resiliently recovers in form in the radial direction to project from the recess 36 outward.

The O-ring 70 is an annular member formed of an elastic material such as rubber. The outer diameter of the O-ring 70 is greater than the inner diameter of the dent of the insertion hole 62. The inner diameter of the O-ring 70 is smaller than the outer diameter of the stem 30.

The O-ring 80 is an annular member formed of an elastic material such as rubber. The outer diameter of the O-ring 80 is greater than the inner diameter of the dent of the drain passage 66. The inner diameter of the O-ring 80 is smaller than the outer diameter of the plug 24. It is noted that, the dent of the drain passage 66 has a lip on the right side in FIG. 1. The inner diameter of the lip is smaller than inner diameter of the dent to enable steady retention of the O-ring 80.

The O-ring 70 is elastically attached to the dent of the insertion hole 62 along the arrow. The O-ring 80 is elastically attached to the dent of the drain passage 66 along the arrow. In the present state, the valve 10 is mounted to the wall 60. Specifically, the stem 30 of the valve 10 is coaxially inserted into the insertion hole 62 of the wall 60 in the axial direction along the arrow. Thus, the valve 10 is mounted to the wall 60 such that the valve 10 is rotatable around the center axis 30a of the stem 30. The valve 10 and the wall 60 may be components of a drain device.

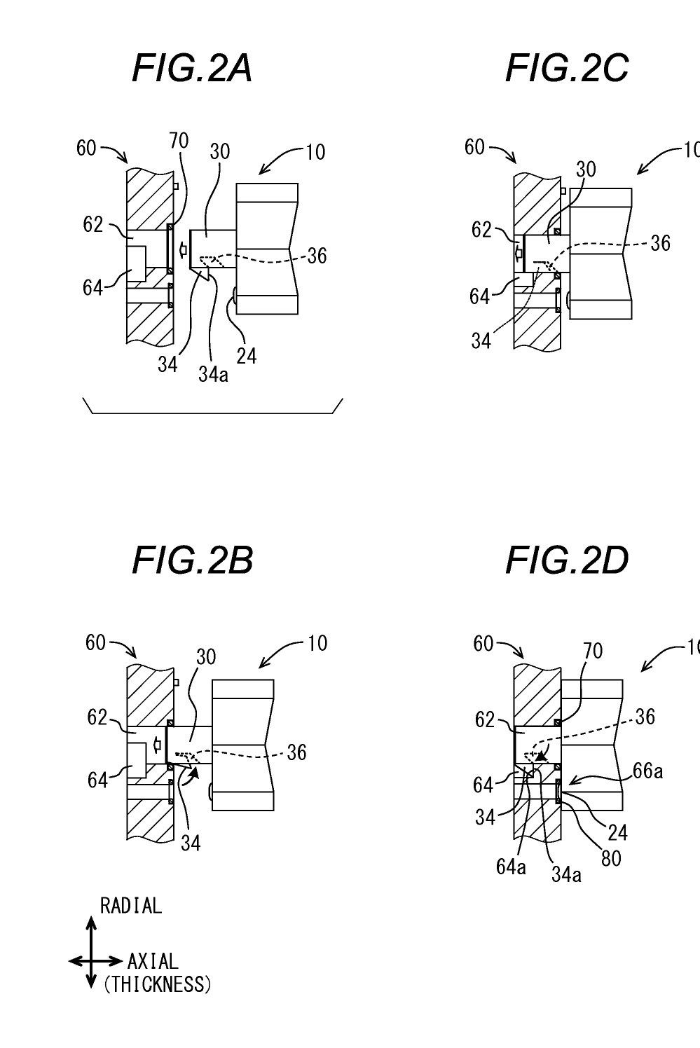

Subsequently, a process to mount the valve 10 to the wall 60 will be described with reference to FIGS. 2A to 2D.

As shown in FIG. 2A, the stem 30 of the valve 10 is coaxially aligned relative to the insertion hole 62 of the wall 60. In the present state, the valve 10 is pressed leftward in FIG. 2A, thereby to insert the tip end of the stem 30 into the O-ring 70 attached to the dent of the insertion hole 62.

As shown in FIG. 2B, the tip end of the stem 30 is inserted into the O-ring 70. As the valve 10 is further pushed leftward in FIG. 2B, the pin 34 is urged from the O-ring 70 inward in the radial direction. Thus, the pin 34 is resiliently bent at the one end and is retracted into the recess 36. As the stem 30 is further pushed into the insertion hole 62, the pin 34 is further retracted into the recess 36.

As shown in FIG. 2C, as the stem 30 is further pushed into the insertion hole 62, the pin 34 is entirely retracted into the recess 36.

As shown in FIG. 2D, the stem 30 is completely pushed into the insertion hole 62, the pin 34 resiliently recovers in form to be projected from the recess 36 into the pin guide 64. In the present state, the end surface 34a of the pin 34 is in contact with the pin seat 64a of the pin guide 64. Thus, the pin 34 is latched onto the pin guide 64, thereby to retain the stem 30 onto the wall 60. The flat seat surface of the knob 20 may be entirely in contact with the flat seat surface of the wall 60.

The O-ring 70 seals a gap formed between the circumferential periphery of the stem 30 and the insertion hole 62. Therefore, the O-ring 70 restricts fluid from leaking through the gap. In addition, the O-ring 70 may resiliently urge the knob 20 rightward in the axial direction, thereby to cause the end surface 34a of the pin 34 to bias the pin seat 64a of the pin guide 64. In this way, the pin 34 may further steadily retain the valve 10 on the wall 60.

The plug 24 is elastically seated on the O-ring 80 to restrict fluid from flowing through the drain port 66a.

FIGS. 3A and 3B show the valve 10 mounted to the wall 60. FIG. 3A shows the valve 10 at a close position to close the drain port 66a. The state shown in FIG. 3A corresponds to the state shown in FIG. 2D. In FIG. 3A, the pin guide 64 formed in the wall 60 is in an arc shape extending in the circumferential direction for about 90 degrees. The pin 34 is directed downward in FIG. 3A and latched onto the pin guide 64 in the circumferential direction. The knob 20 is also latched on the stopper 68a. Thus, rotation of the valve 10 in clockwise direction is prohibited further from the present position by the pin guide 64 and/or the stopper 68a. In FIG. 3A, the valve 10 is rotatable in the counterclockwise direction within a rotational range, which is defined by the pin guide 64 and/or the stopper 68b in the circumferential direction. The rotational range is about 90 degrees and may correspond to the arc shape of the pin guide 64.

FIG. 3B shows the valve 10 at an open position to open the drain port 66a. In FIG. 3B, the valve 10 is rotated in the counterclockwise direction around the stem 30 for about 90 degrees. In the present state, the knob 20 is latched on the stopper 68b. The pin 34 is directed rightward in FIG. 3B and latched onto the pin guide 64 in the circumferential direction. Thus, rotation of the valve 10 in counterclockwise direction is prohibited further from the present position by the pin guide 64 and/or the stopper 68b. In the present state, the plug 24 is away from the drain port 66a to open the drain port 66a, thereby to permit drain to flow through the drain port 66a. It is noted that, the lip of the dent of the drain passage 66 steadily retain the O-ring 80. Therefore, even when the valve 10 is in the open position, the lip avoids detachment of the O-ring 80 from the dent of the drain passage 66.

As described above, the valve 10 can be easily snap-fitted to the wall 60 without a tool. Once the valve 10 is mounted to the wall 60, the pin 34 prohibits detachment of the valve 10 from the wall 60. The valve 10 can be easily manipulated by a user without a tool. The position of the valve 10 is visually confirmed by a user. The pin 34 and the pin guide 64 also regulate rotational range of the valve 10 relative to the wall 60.

The stem 30 has the circumferential periphery without a thread. Therefore, the valve 10 may not be screwed into the insertion hole 62.

The knob 20 may be configured to rotate around the center axis 30a of the stem 30, while the end surface 34a of the pin 34 is seated on the pin seat 64a of the pin guide 64. The present configuration may unable the knob 20 to move in the axial direction relative to the wall 60 while the knob 20 is rotated.

### Second Embodiment

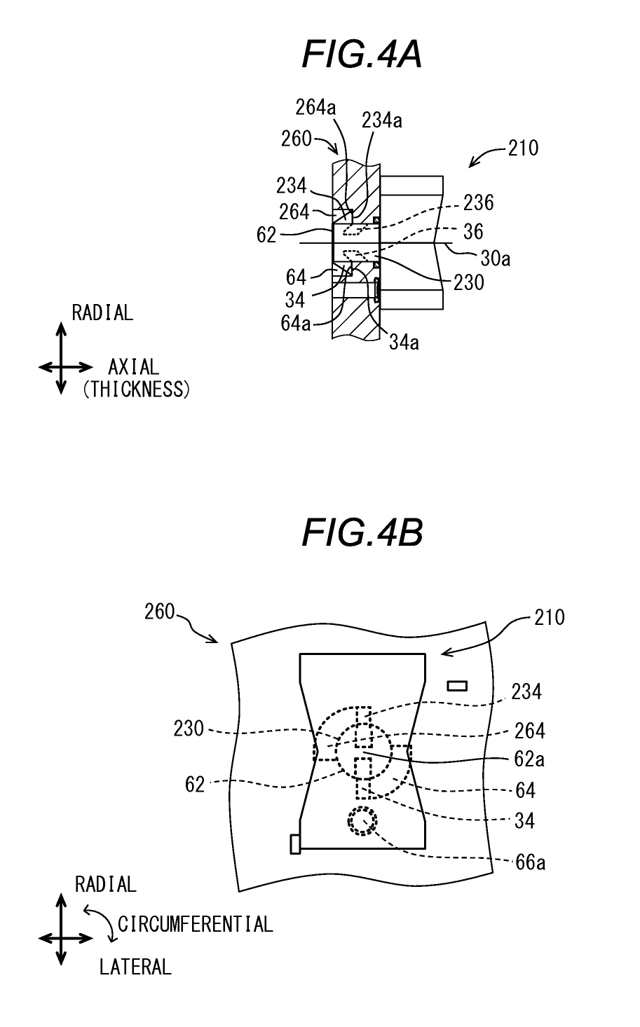

FIGS. 4A and 4B show a drain device according to a second embodiment. A valve (manual valve) 210 has a stem 230 having a second pin 234 and a second recess 236, in addition to the pin 34 (first pin 34) and a recess 36 (first recess 36) described in the first embodiment. A wall 260 has a second pin guide 264, in addition to the pin guide 64 (first pin guide 64) described in the first embodiment.

The second pin 234 is opposed to the first pin 34 in the radial direction. The second recess 236 is opposed to the first recess 36 in the radial direction. That is, the stem 30 is substantially line symmetric in the radial direction.

In FIG. 4B, the second pin guide 264 is located at a position shifted from the first pin guide 64 in the circumferential direction substantially by 180 degrees. That is, the second pin guide 264 is substantially point-symmetric to the first pin guide 64 about the center axis 62a of the insertion hole 62.

In FIG. 4A, the second pin 234 is projected in the radial direction outward from the circumferential periphery of the stem 230. The second pin 234 has a second end surface 234a at a right angle relative to the circumferential periphery of the stem 230. The second recess 236 is dented in the radial direction inward from the circumferential periphery of the stem 230. The second pin 234 is cantilevered at one end. The second pin 234 is resiliently pivoted at the one end and bendable relative to the second recess 236. On receiving force inward in the radial direction, the second pin 234 is resiliently bent in the radial direction inward and retracted into the second recess 236. On releasing the force, the second pin 234 resiliently recovers in form in the radial direction to project outward from the second recess 236.

The second pin guide 264 has a flat bottom surface defining a second pin seat 264a. The second pin seat 264a is at a right angle relative to a periphery of the insertion hole 62. The second end surface 234a of the second pin 234 is in contact with the second pin seat 264a of the second pin guide 264. Thus, the second pin 234 is latched onto the second pin guide 264, thereby to retain the stem 230 onto the wall 260.

In FIG. 4B, the valve 210 is rotatable in the counterclockwise direction within a rotational range, which is defined by both the first pin guide 64 and the second pin guide 264 in the circumferential direction. The rotational range is about 90 degrees correspondingly to the arc shapes of the first pin guide 64 and the second pin guide 264. In addition or alternatively, the rotational range may be regulated by the stoppers 68a, 68b (FIG. 3B).

According to the second embodiment, the second end surface 234a of the second pin 234 is seated on the second pin seat 264a of the second pin guide 264 on the opposite side of the first pin 34 and the first pin guide 64 in the radial direction. That is, the stem 230 is supported at the two positions on the opposite sides in the radial direction. Therefore, the present configuration may effectively restrict inclination of the stem 230 relative to the wall 260 and may fortify alignment of the valve 210 relative to the wall 260.

### Third Embodiment

A valve (manual valve) 310 according to a third embodiment includes the knob 20 and the stem 30 similarly to the first embodiment. The valve 310 is further equipped with a plug (second plug) 326, which is, for example, in a dome shape and is projected from the flat seat surface of the knob 20. The second plug 326 is located substantially on the opposite side of the center axis 30a from the plug (first plug) 24. Both the first plug 24 and the second plug 324 are projected toward the wall 60 (FIG. 1) when the valve 310 is equipped to the wall 60. The present configuration may enable the first plug 24 and the second plug 324 to bias the valve 310 evenly at two positions radially distant from each other.

### Fourth Embodiment

A valve (manual valve) 410 according to a third embodiment includes a knob 420 and the stem 30 similarly to the first embodiment. The valve 410 is equipped with a plug 426, which has a tip end 426a and a body 426b. The tip end 426a and the body 426b may be integrally formed of an elastic material such as rubber.

The tip end 426a is, for example, in a columnar shape. The body 426b is a columnar shape and is extended from the tip end 426a. The plug 424 is press-fitted to a hole formed in the knob 420, such that the tip end 426a is projected from the flat seat surface of the knob 420.

A wall 460 has a similar configuration to that of the first embodiment, excluding a drain port 466a. In the present embodiment, the drain port 466a does not have a dent to receive an O-ring. In addition, in the present embodiment, an O-ring is omitted from the drain port 466a.

The outer diameter of the tip end 426a is same as or greater than the inner diameter of the drain port 466a. When the valve 410 is in the close position, the tip end 426a may be fitted to the drain port 466a, thereby to function as a stopper (rubber stopper). In addition, the present configuration may enable to enhance mechanical strength of the plug 424, which is abraded on the wall surface of the tank wall.

The knob may be equipped with two plugs 424 at opposite positions across the center axis 30a, similarly to the third embodiment. The tip end 426a may be in a dome shape.

### Other Embodiment

The wall 60 may have a plug rail, which is a concavity extending in the circumferential direction along a trajectory (locus) of the plug 24 when the valve 10 is rotated relative to the wall 60. The plug rail may receive the plug 24 when the valve 10 is out of the close position, thereby to restrict the flat seat surface of the knob 20 from inclined relative to the flat seat end surface 34a of the wall 60.

The plug 24 may be omitted from the knob 20. The plug 24 may be a part of the flat seat surface of the knob 20. The plug 24 may be formed of an elastic material and may be adhered to or insert-molded with the flat seat surface of the knob 20. At least one of the stoppers 68a, 68b may be omitted. At least one of the O-ring 70, 80 may be omitted. The valve 10 may be mounted to the wall 60 at the open position.

The second pin 234 may be shifted from the first pin 34 around the center axis of the stem 230 in the circumferential direction at a predetermined angle. The second recess 236 may be shifted from the first recess 36 around the center axis of the stem 230 in the circumferential direction at the predetermined angle. The second pin guide 264 may be shifted from the first pin guide 64 around the center axis of the insertion hole 62 in the circumferential direction at a predetermined angle.

The second plug 326 of the third embodiment may be equipped to the valve 210 of the second embodiment.

The configuration of the plug 424 of the fourth embodiment may be employed in the configurations of the first to third embodiments.

In the forth embodiment, the drain port 466a may have the dent and equipped with the O-ring 80 similarly to the first embodiment.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A manual valve comprising:
a knob; and
a stem projected from the knob, wherein
the stem has a first pin and a first recess,
the first pin is configured to be projected from the stem radially outward and to be retracted into the first recess radially inward,
the first pin has a first end surface configured to latch onto a first pin seat when projected, and
the knob has at least one plug radially offset from a center axis of the stem.

2. The manual valve according to claim 1, wherein the stem has a circumferential periphery without a thread.

3. The manual valve according to claim 1, wherein the first recess is radially dented into the stem and is configured to accommodate the first pin when the first pin is radially retracted.

4. The manual valve according to claim 1, wherein the first end surface is substantially at a right angle relative to the center axis of the stem.

5. The manual valve according to claim 1, wherein
the stem further has a second pin and a second recess,
the second pin is configured to be projected from the stem radially outward and to be retracted into the second recess radially inward,
the second pin has a second end surface configured to latch onto a second pin seat when projected,
the second pin is shifted from the first pin around the center axis of the stem at a predetermined angle, and
the second recess is shifted from the first recess around the center axis of the stem at the predetermined angle.

6. The manual valve according to claim 5, wherein
the second pin is radially opposed to the first pin, and
the second recess is radially opposed to the first recess.

7. A tank wall of a tank for receiving fluid, the tank wall comprising:
an insertion hole extending through the tank wall;
a drain passage extending through the tank wall to enable fluid to flow therethrough, the drain passage being offset radially from the insertion hole; and
a first pin guide overlapped with the insertion hole in both an axial direction and a radial direction, wherein
the first pin guide has a length less than a length of the insertion hole in the axial direction,
the first pin guide extends radially outward from the insertion hole and extends around a center axis of the insertion hole to form an arc hollow in the tank wall, and
the first pin guide has a first pin seat substantially at a right angle relative to the center axis of the insertion hole.

8. The tank according to claim 7, wherein the first pin guide extends around the center axis of the insertion hole substantially for 90 degrees.

9. The tank wall according to claim 7, further comprising:
a second pin guide overlapped with the insertion hole in both the axial direction and the radial direction, wherein
the second pin guide has a length less than the length of the insertion hole in the axial direction,
the second pin guide extends radially outward from the insertion hole and extends around the center axis of the insertion hole to form an arc hollow in the tank wall,
the second pin guide has a second pin seat substantially at a right angle relative to the center axis of the insertion hole, and
the second pin guide is shifted from the first pin guide around the center axis of the insertion hole at a predetermined angle.

10. A drain device comprising:
a manual valve; and
a tank wall, wherein
the manual valve includes a knob and a stem, which is projected from the knob,
the stem has a first pin and a first recess,
the tank wall has an insertion hole, a first pin guide, and a drain passage,
the first pin guide overlaps with the insertion hole in both an axial direction and a radial direction,
the first pin guide extends radially outward from the insertion hole and extends around a center axis of the insertion hole to form an arc hollow to define a first pin seat in the tank wall,
the first pin is projected from the stem radially outward to latch onto the first pin seat when the stem is inserted in the insertion hole, and
the knob is configured to rotate around the center axis of the stem, while the first end surface of the first pin is seated on the first pin seat.

11. The drain device according to claim 10, wherein the first end surface of the first pin is configured to slide on the first pin seat while the manual valve is rotated and to unable the manual valve to move in the axial direction relative to the tank wall.

12. The drain device according to claim 10, wherein
the drain passage extends through the tank wall to enable fluid to flow therethrough,
the drain passage is radially offset from the insertion hole,
the knob has a plug radially offset from the center axis of the stem,
the plug closes the drain passage when the manual valve is at a close position, and
the plug opens the drain passage when the manual valve is at an open position rotated from the close position by a predetermined angle.

13. The drain device according to claim 12, wherein the plug is in a dome shape and is projected from the knob.

14. The drain device according to claim 10, wherein the manual valve is snap fitted to the tank wall by contracting the first pin radially inward and by recovering the first pin radially outward to latch onto the first pin seat.

15. The drain device according to claim 10, wherein
the tank wall has a stopper projected toward the knob, and
the stopper is offset from the center axis of the insertion hole to regulate rotation of the knob.

16. The drain device according to claim 10, wherein
the stem further has a second pin and a second recess,
the tank wall further has a second pin guide,
the second pin guide overlaps with the insertion hole in both the axial direction and the radial direction,
the second pin guide extends radially outward from the insertion hole and extends around the center axis of the insertion hole to form an arc hollow to define a second pin seat in the tank wall,
the second pin is projected from the stem radially outward to latch on the second pin seat when the stem is inserted in the insertion hole,
the second pin is shifted from the first pin around the center axis of the stem at a predetermined angle,
the second recess is shifted from the first recess around the center axis of the stem at the predetermined angle, and
the second pin guide is shifted from the first pin guide around the center axis of the insertion hole at the predetermined angle.

17. The manual valve according to claim 1, wherein the at least one plug include two plugs, which are located on opposite sides across a center axis of the stem.

18. The manual valve according to claim 1, wherein the at least one plug is in a columnar shape and is press-fitted to a hole of the knob.
